(19) United States
(12) Patent Application Publication
(10) Pub. No.: US 2016/0197347 A1
(43) Pub. Date: Jul. 7, 2016

(54) LMFP Cathode Materials with Improved Electrochemical Performance

(71) Applicant: DOW GLOBAL TECHNOLOGIES LLC, Midland, MI (US)

(72) Inventors: Michael S. Paquette, Midland, MI (US); Michael M. Olken, Midland, MI (US); Thierry Drezen, Pont L'abbe (FR)

(21) Appl. No.: 14/911,555

(22) PCT Filed: Sep. 18, 2014
(86) PCT No.: PCT/US14/56374

§ 371 Date: Feb. 11, 2016

Related U.S. Application Data
(60) Provisional application No. 61/884,629, filed on Sep. 30, 2013.

(51) Int. Cl. H01M 4/58; H01M 10/052

(52) U.S. Cl. CPC H01M 4/5825; H01M 10/052; H01M 2004/028

(57) ABSTRACT

LMFP cathode materials are made in a mechanochemical/solid state process. The precursors are dried in a preliminary step to reduce the water content of the precursors of less than 1% by weight and preferably less than 0.25% by weight. The dried precursors are then dry milled and calcined to form particles of an olivine LMFP. The product has excellent specific capacity and capacity retention.

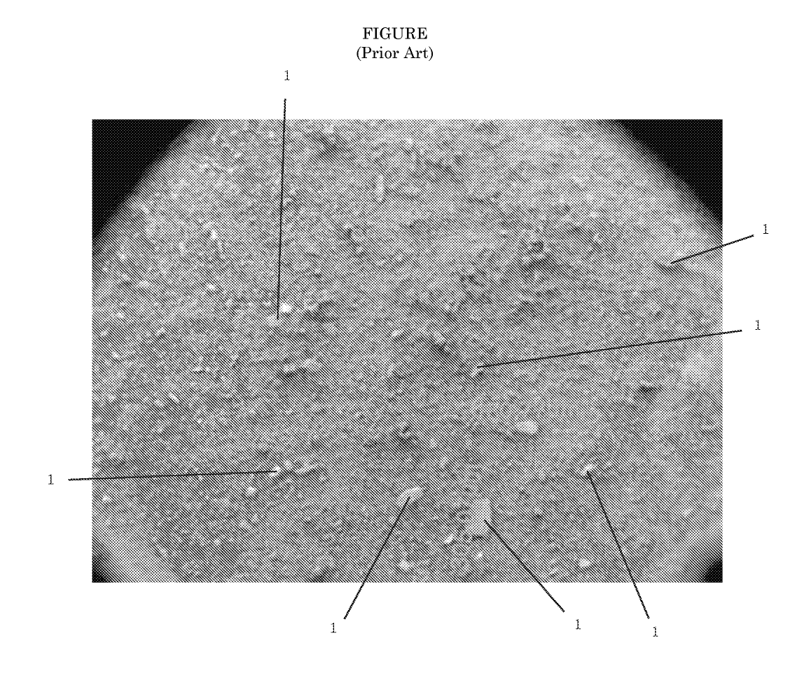

The present invention relates to olivine lithium manganese iron phosphate cathode materials for lithium batteries and to methods for making such materials.

Lithium batteries are widely used as primary and secondary batteries for vehicles and many types of electronic equipment. These batteries often have high energy and power densities.

LiFePO₄ is known as a low cost material that is thermally stable and has low toxicity. It can also demonstrate very high rate capability (high power density) when made with a small particle size and a good carbon coating. For these reasons, LiFePO₄ has found use as a cathode material in lithium batteries. However, LiFePO₄ has a relatively low working voltage (3.4V vs. Li⁺/Li) and because of this has a low energy density relative to oxide cathode materials. In principle, the working voltage and therefore the energy density can be increased by substituting manganese for some or all of the iron to produce an olivine lithium manganese iron phosphate (LiₐMn_{b}Fe_{(1-b)}PO₄, (LMFP)) cathode, without a significant sacrifice of power capability.

In practice, LMFP cathodes have fallen short of their theoretical performance. This is due to several factors, among which is the low intrinsic electronic conducivity of the material. In addition, lithium transport through the olivine crystal structure occurs through one-dimensional channels, which are susceptible to blockage by impurities and defects in the crystal structure. Another problem is that battery cycling performance for LMFP electrodes often is less than desirable, due to a loss of capacity with cycling.

A cost-effective method for preparing a better-performing LMFP cathode material is therefore desired.

Various approaches to making LMFP cathode materials have been evaluated. Among these are various precipitation methods, sol-gel process, and solid-state processes. In solid state processes, stochiometric mixtures of solid precursors are ground and calcined to form the LMFP material. The process tends to form large, low surface area particles which perform poorly as cathode materials.

To overcome this problem, the solid-state process has been modified to include a mechanochemical activation step. Mechanochemical activation is performed by milling the solid precursors before the calcination step. Milling pulverizes and mixes the powders, welding, fracturing and re-welding them, which promotes the intimate mixing of the starting materials. Some reaction of the starting materials also occurs, although single-phase LMFP materials are not obtained until the milled material is calcined.

Despite the milling step and a post-calcination grinding step, the LMFP material produced via the mechanochemical activation/solid-state process tends to produce a significant fraction of large secondary particles. The large particles often have dimensions on the order of several tens of micrometers to hundreds of micrometers. The presence of these large particles slows electron and lithium transport in the battery cathode and hurt cathode performance. The large particles also make it difficult to form thin films of the cathode material. Battery electrodes are often manufactured by applying a thin film of the cathode material (plus binder) onto a metal foil which acts as a current collector. Large particles of cathode material may be larger than the desired cathode film thickness. This prevents one from forming uniform layers of the cathode material. In addition, the larger particles can even puncture or tear the metal foil layer.

Yet another problem is LMFP cathode materials made using the mechanochemical activatin/solid-state process often still have inadequate battery cycling performance.

Applicants have found that these problems can be largely if not entirely overcome by removing water from the starting materials prior to the dry milling step. Therefore, this invention is a mechanochemical/solid state process for manufacturing LMFP cathode materials, the process comprising:

a) dry milling a mixture of precursor particles having a water content of less than 1% by weight, the precursor particles including at least one lithium precursor, at least one manganese (II) precursor, at least one iron (II) precursor and at least one phosphate precursor, optionally a carbonaceous material or precursor thereto and optionally a dopant metal precursor having a fugitive anion, in amounts to provide 0.85 to 1.15 moles of lithium per mole of phosphate ions, and 0.95 to 1.05 moles of manganese (II), iron (II) and dopant metal combined per mole of phosphate ions; and

b) calcining the resulting milled particle mixture under a non-oxidizing atmosphere to form an olivine LMFP powder.

In certain embodiments, the process comprises:

a) drying precursor particles including at least one lithium precursor, at least one manganese (II) precursor, at least one iron (II) precursor and at least one phosphate precursor, optionally a carbonaceous material or precursor thereto and optionally a dopant metal precursor having a fugitive anion, to reduce the water content of the precursors to less than 1% by weight;

b) dry milling a mixture of the dried precursor particles in amounts to provide 0.85 to 1.15 moles of lithium per mole of phosphate ions and 0.95 to 1.05 moles of manganese (II), iron (II) and dopant metal combined per mole of phosphate ions; and

c) calcining the resulting milled particle mixture under a non-oxidizing atmosphere to form an olivine LMFP powder.

Because much of the water present in the precursor materials in conventional processes represents waters of hydration of the iron (II) precursor, if is often sufficient to dry only the iron (II) precursor, to remove the waters of hydration. Therefore, in another embodiment, the invention comprises

a) dry milling precursor particles including at least one lithium precursor, at least one manganese (II) precursor, at least one anhydrous iron (II) precursor and at least one phosphate precursor, optionally a carbonaceous material or precursor thereto and optionally a dopant metal precursor having a fugitive anion, in amounts to provide 0.85 to 1.15 moles of lithium per mole of phosphate ions, and 0.95 to 1.05 moles of manganese (II), iron (II) and dopant metal combined per mole of phosphate ions; and

b) calcining the resulting milled particle mixture under a non-oxidizing atmosphere to form an olivine LMFP powder.

The processes of the invention in their various embodiments offer several unexpected advantages. A very important advantage is that the product is largely free of very large particles. This increases yield to usable product, and reduces or even eliminates costs to remove those large particles from the product before it is used.

The electrochemical performance of the LMFP cathode material is also unexpectedly improved, in at least two respects. First, batteries having a cathode made from this LMFP cathode exhibit usually high capacities when operated at high discharge rates. Secondly, the performance of the cathode material is usually stable during battery cycling. As is demonstrated below, these performance improvements do not easily correlate to the relative absence of large particles in the product. LMFP powers made in conventional process and then sieved to remove the large particles cannot equal the electrochemical performance of LMFP materials synthesized in applicants' process. Applicants' process appears to produce a single-phase olivine material having unusually few crystalline defects and impurities.

The Figure is a micrograph of LMFP particles made in a prior art process as described in Comparative Sample A below.

The dry milling step of the invention is performed in a dry agitated media mill, such as a sand mill, ball mill, attrition mill, mechanofusion mill, or colloid mill, and/or a grinding device. Ball mills are generally preferred types. The precursors are introduced as dry particulate solids, “dry” in this context meaning there is no liquid phase present. The media mill contains grinding media, which may be, for example ceramic or metallic beads, rollers, etc. The dry milling step may be performed in two or more sub-steps. For example, in a first sub-step larger milling media may be used to provide a finely milled product having a particle size in the range of, for example, 0.2 to 1 microns. In a second sub-step, smaller grinding media may be used to further reduce the particle size into the range of, for example, 0.01 to 0.1 microns.

The dry milling step is conveniently performed at a temperature from 0 to 250° C., preferably 0 to 100° C. and more preferably 0 to 50° C. Typically, it is not necessary to heat the precursors or the mill during the milling step. Some heating of the materials is usually seen due to the mechanical action of the milling media on the precursors. Conditions during the dry milling step are generally selected to avoid calcining the precursors.

The dry milling step may be performed for a period of, for example, 5 minutes to 10 hours. The amount of dry milling can be expressed in terms of the energy used in the process; the amount of milling energy used to dry mill the particles is typically 10 to 12,000 kWh/tonne of starting precursors and preferably <2000 kWh/tonne. These energy amounts do not include energy lost due to mechanical friction of the motor driving the mill or other mechanical losses that occur in the milling apparatus.

During the dry milling step, the particle size of the precursors is reduced and the various precursors become intimately mixed. Welding, fracturing and re-welding of particles is often seen. Some reaction of the precursors may occur during the dry milling step. However, little olivine LMFP material is believed to form during this step. Some loss of fugitive anions and volatile reaction products may occur during this step although, again, much of the loss of fugitive materials occurs in the subsequent calcining step.

The precursors taken into the dry milling step are materials that react during the milling and subsequent calcining steps to form an olivine LMFP or, in the where a carbonaceous material or precursor thereto is present, a nanocomposite of the olivine LMFP and the carbonaceous material. The olivine LMFP may have the empirical formula LiₐMn_{b}Fe_{c}D_{d}PO₄, wherein a is a number from 0.85 to 1.15; b is from 0.05 to 0.95; c is from 0.049 to 0.95; d is from 0 to 0.1; 2.75≦(a+2b+2c+dV)≦3.10, V is the valence of D, and D is a metal ion selected from one or more of magnesium, calcium, strontium, cobalt, titanium, zirconium, molybdenum, vanadium, niobium, nickel, scandium, chromium, copper, zinc, beryllium, lanthanum and aluminum.

In some embodiments, the value of b is from 0.5 to 0.9 and the value of a is from 0.49 to 0.1. In other embodiments, the value of b is from 0.65 to 0.85 and the value of a is from 0.34 to 0.15.

The LMFP precursors are provided in stoichiometric amounts, i.e., in amounts that provide lithium, iron (II), manganese (II), dopant metal and phosphate ions in the same molar ratios as in the product olivine LMFP material. The carbonaceous material or precursor thereto is generally provided in an amount such that that resulting nanocomposite contains up to 30% carbonaceous material, preferably up to 10% by weight thereof.

The water content of the precursors is in some embodiments less than 1% by weight. The water content includes any waters of hydration as may be present in the various precursor materials, which are typically salts and in some cases may be somewhat hygroscopic. If these waters of hydration are present in one or more of the precursor materials, some or all of them should be removed as necessary to reduce the water content of the precursors to less than 1% by weight.

The water precursors content of the precursors preferably is less than 0.25% by weight, more preferably less than 0.1% by weight, still more preferably less than 0.025% by weight, and even more preferably les than 0.01% by weight

The water content of the precursors as expressed above applies to the precursors collectively, not to the individual precursors. One or more of the individual precursors may have a water content of 1 weight percent or more if the total water content of all the precursors combined is less than 1 weight percent.

The iron (II) precursor in particular is apt to contain waters of hydration. A preferred iron (II) precursor, for example, is iron (II) oxalate, which typically contains two waters of hydration. Iron (II) oxalate dihydrate contains about 15-20% by weight water. Removing the waters of hydration from the iron (II) precursor therefore is often sufficient to reduce the water content of the combined precursors to the necessary level.

In some embodiments, some or all of the water of hydration of the iron (II) precursor is removed so the iron (II) precursor is anhydrous or nearly so. Using an anhydrous iron (II) precursor, or an iron (II) precursor having at least some of its water of hydration removed, instead of one carrying its normal water of hydration is often sufficient to bring the overall water content of the precursors to less than 1% by weight. Therefore, in some embodiments of the invention, the iron (II) precursor is anhydrous iron (II) oxalate. In other embodiments, the iron (II) precursor contains from 0.0001 to 0.25 moles of water of hydration per mole of precursor.

Iron (II) precursors having reduced (including zero) water of hydration can be prepared by drying the precursor material. Therefore, in some embodiments of the invention, the iron (II) precursor is subjected to a preliminary drying step prior to the dry milling step. Free water also may be removed during the drying step, in addition to some or all of the water of hydration.

Other precursor materials also may contain reduced or no water of hydration. Any or all of the other precursor materials may be dried in a preliminary drying step prior to the dry milling step. As with the iron (II) precursor, free water may also be removed from these other precursor materials, instead of or in addition to water of hydration.

When a preliminary drying step is performed, the precursors are may be dried individually, or all together, or in any subcombination of any two or more of the precursors. In some embodiments, the precursors are mixed together in the propotions in which they will be used in the dry milling step, and the mixture is dried.

The drying step is performed under conditions of elevated temperature and/or subatmospheric pressure. When an elevated temperature is used, the temperature should not be high enough to calcine the precursors or decompose them apart from removing water. A temperature of 20 to 250° C. is suitable. A temperature of 100 to 250° C. is preferred. A more preferred temperature is 100 to 200° C. If a subatmospheric pressure is used, the pressure may be, for example 0.001 to 100 kPa, preferably 0.001 to 10 kPa.

The drying step is continued until the water content of the precursors is reduced to levels as described above. This may take from several minutes to several hours, depending on the apparatus, the temperature, the pressure, the water content of the starting materials, and other factors. Drying may be continued until a constant weight is achieved, as attainment of a constant weight is often indicative of essentially complete removal of water from the precursor or precursors being treated.

The precursor materials are compounds other than a LMFP, and are compounds which react to form a LMFP as described herein. Some or all of the precursor materials may be sources for two or more of the necessary starting materials.

Suitable lithium precursors include, for example, lithium hydroxide, lithium oxide, lithium carbonate, lithium dihydrogen phosphate, lithium hydrogen phosphate and lithium phosphate. Lithium dihydrogen phosphate, dilithium hydrogen phosphate and lithium phosphate all function as a source for both lithium ions and HₓPO₄ ions, and can be formed by partially neutralizing phosphoric acid with lithium hydroxide prior to being combined with the rest of the precursor materials.

Suitable manganese precursors include, for example, manganese (II) hydrogen phosphate and manganese (II) compounds which have a fugitive anion. By “fugitive”, it is meant a species which forms one or more volatile by-products during the dry milling and/or calcining step and thus is removed from the reaction mixture as a gas. The volatile by-product may include, for example, oxygen, water, carbon dioxide, an alkane, a alcohol or polyalcohol, a carboxylic acid, a polycarboxylic acid or a mixture of two or more thereof. Examples of fugitive anions include, for example, hydroxides, oxides, oxalate, hydroxide, carbonate, hydrogen carbonate, formate, acetate, other alkanoate having up to 18 carbon atoms, polycarboxylate ions, having up to 18 carbon atoms such as citrate, tartrate and the like, alkanolate ions having up to 18 carbon atoms and glycolate ions having up to 18 carbon atoms. Manganese (II) compounds of any of these fugitive anions are useful herein. Manganese (II) carbonate is a preferred manganese precursor.

Suitable iron precursors include iron (II) hydrogen phosphate and iron (II) compounds of any of the fugitive anions mentioned in the previous paragraph. Examples include iron (II) carbonate, iron (II) hydrogen carbonate, iron (II) formate, iron (II) acetate, iron (II) oxide, iron (II) glycolate, iron (II) lactate, iron (II) citrate and iron (II) tartrate. Iron (II) oxalate is a preferred iron precursor.

Suitable precursors for the dopant metal include, for example, compounds of the dopant metal with a fugitive anion. Examples of suitable such dopant metals precursors include, for example, magnesium carbonate, magnesium formate, magnesium acetate, cobalt (II) carbonate, cobalt (II) formate and cobalt (II) acetate.

Suitable precursors for H_{z}PO₄ ions include, in addition to the lithium hydrogen phosphate, lithium dihydrogen phosphate and iron (II) phosphate compounds listed above, phosphoric acid, tetraalkyl ammonium phosphate compounds, tetraphenyl ammonium phosphate compounds, ammonium phosphate, ammonium dihydrogen phosphate, and the like. The ammonium and hydrogen cations tend to be fugitive, and therefore are preferred over non-fugitive cations such as metal cations.

A carbonaceous material or precursor thereof may be included in the mixture that is taken to the milling step. Suitable carbonaceous materials include, for example, graphite, carbon black and/or other conductive carbon. Precursors include organic compounds which decompose under the conditions of the calcination reaction to form a conductive carbon. These precursors include various organic polymers, sugars such as sucrose or glucose, and the like.

A preferred mixture of starting materials includes lithium dihydrogen phosphate as the precursor for both lithium and phosphate ions, manganese (II) carbonate as the manganese (II) precursor and iron (II) oxalate as the iron (II) precursor.

The precursors are provided in the form of fine powders. The primary particle sizes preferably are less than 50 micrometers (as measured by laser diffraction or light diffraction methods) and preferably no greater than 10 micrometers. The precursors can be screened if desired to remove very large particles and/or agglomerates.

The product obtained from the dry milling step is calcined to form the olivine LMFP material or nanocomposite. A suitable calcining temperature is 350 to 750° C. and preferably 500 to 700° C., for 0.1 to 20 hours and preferably 1 to 4 hours. Conditions are selected to avoid sintering the particles.

The calcining step is performed in a non-oxidizing atmosphere. Examples of non-oxidizing atmospheres include nitrogen; mixtures of nitrogen and oxygen in which the oxygen content is less than 1% by weight, especially less than 500 ppm by weight; hydrogen, helium, argon, and the like.

During the calcining step, fugitive by-products evolve and are removed from the forming product as gases. The non-fugitive materials form an olivine LMFP structure. If a carbonaceous material or precursor thereof is present during the calcining step, the calcined particles will take the form of a nanocomposite of the olivine material and the carbonaceous material. The carbonaceous material may form a carbonaceous coating on the powdered particles, and/or form a layered composite therewith.

The extent of reaction can be followed using gravimetric methods (which measure the loss of fugitive by-products), by X-ray diffraction methods (which indicate the formation of the desired olivine crystalline structure) and/or by other techniques if desired. The reaction preferably is continued until a single phase LMFP material or nanocomposite is obtained.

The product obtained from the calcining step may be lightly ground to break up aggregates if desired. Often, the product obtained from the calcining step can be used directly without further treatment.

An advantage of the invention is that few if any very large particles form during the dry milling and calcining steps. In prior art processes, in which water is present, a small fraction of very large, slab-like particles tends to form. The slab-like particles are not simple aggregates of smaller particles, which can be easily broken into primary particles or smaller agglomerates with light grinding. Instead, these large slab-like particles tend to be very large primary particles that are not easily broken down with light grinding. Those slab-like particles often have longest dimensions in excess of 100 micrometers. They may constitute up to 5% of the total volume of the product. The formation of these particles is nearly if not entirely eliminated in the inventive process.

The presence of large particles is reflected in D90 and D99 particle sizes for the dry milled intermediates as well as the final product. The D90 particle size represents the size equal to or larger than the smallest 90 volume percent of the particles and smaller than the largest 10 volume percent of the particles. The D99 particle size represents the size equal to or larger than the smallest 99 volume percent of the particles and smaller than the largest 1 volume percent of the particles.

D90 values often are reduced very substantially, by 25 to 80% or more, for the dry milled intermediates and the LMFP product of the invention, compared to prior art process in which the water content of the precursors is high. D99 values are often similarly reduced. For example, D90 particle sizes for dry milled intermediates and LMFP products of the invention are typically in the range of 10 to 60 micrometers, as measured by laser diffraction methods. This compares with values from 50 to 150 micrometers in prior art processes. D99 particle sizes are typically in the range of 50 to 100 micrometers for this process (again as measured by laser diffraction methods), compared with 150 to 500 micrometers or even more for the prior art process. The lower D90 and D99 values are indicative of much lower contents of large particles.

The LMFP material (or nanocomposite) made in accordance with the invention is useful as a cathodic material. It can be formulated into cathodes in any convenient manner, typically by blending it with a binder, forming a slurry and casting it onto a current collector. The cathode may contain particles and/or fibers of an electroconductive material such as graphite, carbon black, carbon fibers, carbon nanotubes, metals and the like.

The relative absence of large particles makes the LMFP materials of the invention (and nanocomposites) very suitable for use in forming cathodic films.

The cathodes are useful in lithium batteries. A lithium battery containing such a cathode can have any suitable design. Such a battery typically comprises, in addition to the cathode, an anode, a separator disposed between the anode and cathode, and an electrolyte solution in contact with the anode and cathode. The electrolyte solution includes a solvent and a lithium salt.

Suitable anode materials include, for example, carbonaceous materials such as natural or artificial graphite, carbonized pitch, carbon fibers, graphitized mesophase microspheres, furnace black, acetylene black, and various other graphitized materials. Suitable carbonaceous anodes and methods for constructing same are described, for example, in U.S. Pat. No. 7,169,511. Other suitable anode materials include lithium metal, lithium alloys, other lithium compounds such as lithium titanate and metal oxides such as TiO₂, SnO₂ and SiO₂, as well as materials such as Si, Sn, or Sb.

The separator is conveniently a non-conductive material. It should not be reactive with or soluble in the electrolyte solution or any of the components of the electrolyte solution under operating conditions. Polymeric separators are generally suitable. Examples of suitable polymers for forming the separator include polyethylene, polypropylene, polybutene-1, poly-3-methylpentene, ethylene-propylene copolymers, polytetrafluoroethylene, polystyrene, polymethylmethacrylate, polydimethylsiloxane, polyethersulfones and the like.

The battery electrolyte solution has a lithium salt concentration of at least 0.1 moles/liter (0.1 M), preferably at least 0.5 moles/liter (0.5 M), more preferably at least 0.75 moles/liter (0.75 M), preferably up to 3 moles/liter (3.0 M), and more preferably up to 1.5 moles/liter (1.5 M). The lithium salt may be any that is suitable for battery use, including lithium salts such as LiAsF₆, LiPF₆, LiPF₄(C₂O₄), LiPF₂(C₂O₄)₂, LiBF₄, LiB(C₂O₄)₂, LiBF₂(C₂O₄), LiClO₄, LiBrO₄, LiIO₄, LiB(C₆H₅)₄, LiCH₃SO₃, LiN(SO₂C₂F₅)₂, and LiCF₃SO₃. The solvent in the battery electrolyte solution may be or include, for example, a cyclic alkylene carbonate like ethyl carbonate; a dialkyl carbonate such as diethyl carbonate, dimethyl carbonate or methylethyl carbonate, various alkyl ethers; various cyclic esters; various mononitriles; dinitriles such as glutaronitrile; symmetric or asymmetric sulfones, as well as derivatives thereof; various sulfolanes, various organic esters and ether esters having up to 12 carbon atoms, and the like.

The battery is preferably a secondary (rechargeable) battery, more preferably a secondary lithium battery. In such a battery, the charge reaction includes a dissolution or delithiation of lithium ions from the cathode into the electrolyte solution and concurrent incorporation of lithium ions into the anode. The discharging reaction, conversely, includes an incorporation of lithium ions into the cathode from the anode via the electrolyte solution.

The battery containing a cathode which includes lithium transition metal olivine particles made in accordance with the invention can be used in industrial applications such as electric vehicles, hybrid electric vehicles, plug-in hybrid electric vehicles, aerospace vehicles and equipment, e-bikes, etc. The battery of the invention is also useful for operating a large number of electrical and electronic devices, such as computers, cameras, video cameras, cell phones, PDAs, MP3 and other music players, tools, televisions, toys, video game players, household appliances, medical devices such as pacemakers and defibrillators, among many others.

Lithium batteries containing a cathode which includes the LMFP material made in accordance with the invention have surprisingly been found to have excellent capacities, especially at high C-rates.

Secondary batteries containing a cathode which includes LMFP material of the invention exhibit unexpectedly good capacity retention upon battery cycling (i.e., subjecting the battery to repeated charge/discharge cycles), while retaining specific capacity and rate performance. In a secondary (rechargeable) battery, the good capacity retention correlates to long battery life and more consistent performance of the battery as it is repeatedly charged and discharged. This good capacity retention is seen at ambient temperature (20-25° C.) and at somewhat elevated temperatures (40-50° C.) as are often produced during the operation of an electrical device that contains the battery (and to which energy is supplied by the battery).

The following examples are provided to illustrate the invention, but are not intended to limit the scope thereof. All parts and percentages are by weight unless otherwise indicated.

### EXAMPLES 1-3 AND COMPARATIVE SAMPLES A AND B

Comparative Sample A is made as follows: 0.54 parts MnCO₃ powder, 0.63 parts LiH₂PO₄, 0.18 parts of Fe(II)(C₂O₄)₂.2H₂O and 0.089 parts of Ketjenblack EC-600 JD carbon black are combined in a CM20 high energy mill (Zoz GmbH), and milled for three hours. A sample of the resulting milled mixture is taken for particle size analysis using a Microtrack S3500 laser diffraction particle size analyzer. The sample has a D50 of 11.2 μm, a D90 of 50.6 μm and a D99 of 240 μm. About 5 volume percent of the material consists of large, slab-like particles having sizes from 100 to 1000 μm. A micrograph of a sample of the milled material forms the Figure. In the Figure, some of the large slabs are identified by reference numerals 1.

The milled mixture is calcined by heating from room temperature to 530° C. over one hour, holding at 530° C. for three hours, and then cooling back to 100° C. over four hours, all under a flowing nitrogen stream. Water, carbon monoxide and carbon dioxide evolve as fugitive reaction products during the calcination step. The particle size distribution of the calcined product is measured as before. The D50, D90 and D99 for this material are 15.3, 101 and 362 μm, respectively.

The calcined material is formed into a cathode by slurrying it with carbon fiber and poly(vinylidene fluoride) at a solids weight ratio of 93:2:5. A film is cast on aluminum foil by drawing down the slurry. The film is dried overnight at 80° C. The dried films are then punched to make electrode disks. The disks are characterized for thickness and weighed to calculate the active materials loading. The disks are then pressed to a target density of 1.3-1.5 gm/cm³ of active material, and dried under vacuum at 150° C. overnight. A Swagelok cell is assembled and placed on a Maccor battery tester for electrochemical measurements.

The cell is charged at a constant 1C rate to a voltage of 4.25 V. The cell is then discharged at 4.25 V until the current decays to C/100. The cell is then discharged at various rates until the voltage drops to 2.7V. Each discharge is followed with a full charge to 4.25 V. The discharge rates are, in order, C/10, C10, 1C, 5C, C/10 and C/10. Capacity is calculated at the 5C and C/10 discharge rates. The C/10 discharge capacity is 137 mAh/g and the 5C discharge capacity is 97 mAh/g.

To form Comparative Sample B, a portion of the milled mixture described above is sieved through a US 400 mesh sieve to remove the large slabs. The sieved material has a D50 of 10.3 μm, a D90 of 28.5 μm and a D99 of 60 μm. The sieved material is then calcined in the same way as Comparative Sample A, and the calcined material is formed into an electrode and tested, also in the same manner as Comparative Sample A. Results are as indicated in Table 1.

Example 1 is formed in the same manner as Comparative Sample A, except the precursor materials are all dried individually at 105° C. for 16 hours prior to being combined and milled.

Example 2 is formed in the same general manner as Comparative Sample A, except the precursors are all sieved through a US 400 mesh sieve and then dried at 105° C. for 16 hours prior to the milling step.

Example 3 is formed in the same general manner as Comparative Sample A, except the precursors are dried at 105° C. for 16 hours prior to the milling step, and the milled material is sieved through a US 400 mesh sieve prior to the calcing step.

Particle size data and electrochemical data are obtained for each of Examples 1-3 in the manner described for Comparative Sample A. Results are as indicated in Table 1.

TABLE 1

| | Particle Size Distribution (all sizes in μm) | | | | | | Specific | |
|---|---|---|---|---|---|---|---|---|
| | | | | Calcined LMFP | | | Capacity | |
| Sample | Milled Precursors | | | Composite | | | mAh/g | |
| Designation | D50 | D90 | D99 | D50 | D90 | D99 | C/10 | 5 C |
| A* | 11.2 | 50.6 | 249 | 15.3 | 101 | 352 | 137 | 97 |
| B* | 10.3 | 28.5 | 60 | 12.0 | 30.8 | 68 | 138 | 97 |
| 1 | ND | ND | ND | 12.5 | 53.6 | 209 | 141 | 112 |
| 2 | 8.5 | 38.3 | 101 | 10.6 | 26.9 | 52 | 142 | 113 |
| 3 | 10.5 | 31.7 | 72 | 10.2 | 29.7 | 62 | 140 | 110 |

ND—not determined.
*Not an example of this invention.

The data in Table 1 demonstrates the benefits of performing the drying step in accordance with the invention. Specific capacities at C/10 are slightly higher for Examples 1-3 than for the comparatives, but a very significant difference is seen at the higher (5C) discharge rate. Examples 1-3 have approximately 15% higher specific capacities at the 5C discharge rate.

The higher capacities of Examples 1-3 are not simply an artifact of particle size. This is clearly demonstrated by the results obtained with Example 1, which has a significantly larger particle size than Comparative Sample B*, but performs significantly better. Example 1 also performs comparably to Examples 2 and 3, although Examples 2 and 3 have much smaller particles sizes.

### EXAMPLES 4-6 AND COMPARATIVE SAMPLE C

Comparative Sample C: An LMFP/carbon nanocomposite in which the LMFP has the empirical formula LiMn_{0.8}Fe_{0.2}PO₄ is prepared by dry milling a mixture of LiH₂PO₄, MnCO₃, Fe(C₂O₄).2H₂O and Ketjenblack EC-600 JD carbon black in a CM20 high energy mill from Zoz GmbH as described with respect to earlier examples. The milled material is then calcined as described in the earlier examples. The calcined product is formed into a cathode as described before. Electrical testing is performed in the general manner described before.

Example 4 is made and tested in the same manner, except the precursors are individually dried at 105° C. for 16 hours prior to the dry milling step.

Example 5 is made and tested in the same manner as Comparative Sample C, except the iron oxalate dihydrate is replaced with an equal molar amount of anhydrous iron oxalate.

Example 6 is made and tested in the same manner as Example 6, except the precursors are individually dried at 105° C. for 16 hours prior to the dry milling step.

Results of the electrochemical testing are indicated in Table 2.

TABLE 2

| | | Specific Capacity, mAh/g | | | | |
|---|---|---|---|---|---|---|
| | | | | | C/10, | C/10, |
| | | | | | 3.7 V, | 3.7 V, |
| Sample | | | | | 2^{nd} | 7^{th} |
| Designation | Description | C/10 | 1 C | 5 C | cycle | cycle |
| C* | Iron oxalate | 145 | 134 | 103 | 104 | 103 |
| | dihydrate, no | | | | | |
| | precursor drying | | | | | |
| 4 | Iron oxalate | 146 | 138 | 112 | 107 | 106 |
| | dihydrate, | | | | | |
| | precursors | | | | | |
| | dried | | | | | |
| 5 | Anhydrous iron | 148 | 138 | 106 | 108 | 106 |
| | oxalate, no | | | | | |
| | further precursor | | | | | |
| | drying | | | | | |
| 6 | Anhydrous iron | 149 | 140 | 113 | 109 | 109 |
| | oxalate, | | | | | |
| | precursors dried | | | | | |

*Not an example of the invention.

Examples 4-6 are seen to have significantly higher specific capacities (relative to Comparative Sample C) at the 1C and 5C discharge rates, and also at the C/10 rate after both the second and seventh cycles.

### EXAMPLES 7-9 AND COMPARATIVE SAMPLE D

Comparative Sample D: An LMFP/carbon nanocomposite in which the LMFP has the empirical formula Li_{1.025}Mn_{0.8}Fe_{0.2}PO₄ is prepared by dry milling a mixture of LiH₂PO₄, MnCO₃, Fe(C₂O₄).2H₂O and Ketjenblack EC-600 JD carbon black in a CM20 high energy mill from Zoz GmbH as described with respect to earlier examples. 100 grams of the milled material is then calcined at 530° C. for 3 hours in a porcelain crucible. The calcined product is formed into a cathode as described before. Electrochemical testing is performed in the general manner described with respect to Examples 4-6.

Examples 7-9 are all made and tested in the same manner, except the precursors are individually dried at 105° C. for 16 hours prior to the dry milling step, and the milled material is sieved through a US 400 mesh sieve prior to the calcination. The calcination is performed in 750 gram batches in a Pyrex tray. Electrochemical testing is performed in the same manner as Comparative Sample D.

Results are as indicated in Table 3.

TABLE 3

| | | Specific Capacity, mAh/g | | | | | |
|---|---|---|---|---|---|---|---|
| | | | | | | C/10, | |
| Sample | | | | | | 3.7 V, | C/10, |
| Desig- | | | | | | 2^{nd} | 3.7 V, |
| nation | Description | C/10 | 1 C | 5 C | 10 C | cycle | 7^{th} cycle |
| D* | No precursor | 151 | 132 | 79 | 33 | 113 | 109 |
| 7 | drying | 154 | 143 | 115 | 75 | 116 | 114 |
| | Precursors | | | | | | |
| | dried, milled | | | | | | |
| | product sieved | | | | | | |
| 8 | Precursors | 154 | 143 | 113 | 71 | 116 | 116 |
| | dried, milled | | | | | | |
| | product sieved | | | | | | |
| 9 | Precursors | 155 | 143 | 116 | 58 | 119 | 118 |
| | dried, milled | | | | | | |
| | product sieved | | | | | | |

*Not an example of the invention.

Examples 7-9 exhibit much greater capacities than does Comparative Sample D, especially at the 1C, 5C and 10C discharge rates.

### EXAMPLES 10 AND 11 AND COMPARATIVE SAMPLES E AND F

An LMFP/carbon nanocomposite in which the LMFP has the empirical formula Li_{1.025}Mn_{0.8}Fe_{0.2}PO₄ is prepared by dry milling a mixture of LiH₂PO₄, MnCO₃, Fe(C₂O₄).2H₂O and Ketjenblack EC-600 JD carbon black in a CM20 high energy mill from Zoz GmbH as described with respect to earlier examples. The milled mixture is calcined in a Roller Hearth Kilm Simulator. This apparatus has saggers which hold the sample as it is calcined. For Comparative Sample F, the saggers are filled with 3.6 kg of the milled material. Calcination is performed at 530° C. for 3 hours. Samples taken from the top and the bottom of the saggers are taken for electrochemical testing. Electrochemical testing is performed on the calcined material in the general manner described with respect to Examples 7-9.

Comparative Sample F is made and tested in the same way, except the saggers of the kiln simulator are filled with only 1.8 kg of milled precursors.

Example 10 is made and tested in the same way as Comparative Sample E, except the precursors are individually dried at 105° C. for 3 hours and the milled precursors are sieved through a US 400 mesh sieve before calcining.

Example 11 is made and tested in the same way as Comparative Sample E, except the iron oxalate dihydrate is replaced with an equimolar amount of anhydrous iron oxalate.

Results of the electrochemical testing are as indicated in Table 4.

TABLE 4

| | | | Specific Capacity, mAh/g | | | | | |
|---|---|---|---|---|---|---|---|---|
| | | | | | | | C/10, | C/10, |
| Sample | | | | | | | 3.7 V, | 3.7 V, |
| Designation | Description | | C/10 | 1 C | 5 C | 10 C | 2^{nd} cycle | 7^{th} cycle |
| E* | No precursor | Sample | 138 | 120 | 90 | 56 | 89 | 88 |
| | drying, 3.6 kg | from top of | | | | | | |
| | loading in kiln | sagger. | | | | | | |
| | simulator | Sample | 146 | 131 | 103 | 63 | 99 | 96 |
| | saggers. | from | | | | | | |
| | | bottom of | | | | | | |
| | | sagger. | | | | | | |
| F* | No precursor | Sample | 148 | 136 | 106 | 56 | 102 | 99 |
| | drying, 1.8 kg | from top of | | | | | | |
| | loading in kiln | sagger. | | | | | | |
| | simulator | Sample | 146 | 133 | 99 | 64 | 100 | 99 |
| | saggers. | from | | | | | | |
| | | bottom of | | | | | | |
| | | sagger. | | | | | | |
| 10 | Precursors dried, | Sample | 149 | 137 | 107 | 69 | 104 | 100 |
| | milled product | from top of | | | | | | |
| | sieved, 3.6 kg | sagger. | | | | | | |
| | loading in kiln | Sample | 150 | 139 | 105 | 63 | 103 | 100 |
| | simulator | from | | | | | | |
| | saggers. | bottom of | | | | | | |
| | | sagger. | | | | | | |
| 11 | Precursors dried, | Sample | 148 | 134 | 100 | 61 | 99 | 95 |
| | milled product | from top of | | | | | | |
| | sieved, 3.6 kg | sagger. | | | | | | |
| | loading in kiln | Sample | 146 | 130 | 93 | 51 | 96 | 93 |
| | simulator | from | | | | | | |
| | saggers. | bottom of | | | | | | |
| | | sagger. | | | | | | |

Comparative Samples E and F show the effect of powder loading using conventional precursors. In Comparative Sample E, a very large variation in specific capacity is seen between samples taken from the top and the bottom of the sagger. By reducing the loading by 50% (Comparative Sample F), it is possible to obtain a more consistent product, but at a large loss of production capacity. With prior art materials, one must operate well below equipment capacity to obtain consistent product quality throughout the batch. Examples 10 and 11 show that much better product consistently is obtained, even at the large production batch size, when dried precursors are used in accordance with this invention.

1-3. (canceled)

4. A mechanochemical/solid state process for manufacturing LMFP cathode materials, the process comprising:
a) prior to performing a dry milling step b), drying precursor particles including at least one lithium precursor, at least one manganese (II) precursor, at least one iron (II) precursor and at least one phosphate precursor, optionally a carbonaceous material or precursor thereto and optionally a dopant metal precursor having a fugitive anion, to reduce the water content of the precursors to less than 1% by weight;
b) after step a), dry milling a mixture of the dried precursor particles in amounts to provide 0.85 to 1.15 moles of lithium per mole of phosphate ions and 0.95 to 1.05 moles of manganese (II), iron (II) and dopant metal combined per mole of phosphate ions; and
c) calcining the resulting milled particle mixture under a non-oxidizing atmosphere to form an olivine LMFP powder.

4. (canceled)

5. The process of claim 4, wherein in step a), the precursors are dried to reduce the water content of the precursors less than 0.1% by weight.

6. (canceled)

7. The process of claim 4, wherein the lithium precursor includes one or more of lithium dihydrogen phosphate, dilithium hydrogen phosphate and lithium phosphate.

8. The process of claim 4, wherein the manganese (II) precursor is a manganese (II) compound that has a fugitive anion.

9. The process of claim 8, wherein the manganese (II) precursor is manganese (II) carbonate.

10. The process of claim 4, wherein the iron (II) precursor is an iron (II) compound that has a fugitive anion.

11. The process of claim 10, wherein the iron (II) precursor is iron (II) oxalate.
